(19) United States
(12) Patent Application Publication
(10) Pub. No.: US 2019/0122589 A1
(43) Pub. Date: Apr. 25, 2019

(54) THREE-DIMENSIONAL CONTAINER LABEL AND METHOD OF USE

(71) Applicant: William` G. Hupp, Kansas City, MO (US)

(72) Inventor: William` G. Hupp, Kansas City, MO (US)

(21) Appl. No.: 16/220,133

(22) Filed: Dec. 14, 2018

Related U.S. Application Data
(63) Continuation-in-part of application No. 15/677,879, filed on Aug. 15, 2017.
(60) Provisional application No. 62/375,099, filed on Aug. 15, 2016.

(51) Int. Cl. G09F 3/00; G09F 3/03

(52) U.S. Cl. CPC G09F 3/0289; G09F 2003/0216; G09F 3/0388

(57) ABSTRACT

A three-dimensional label with an easy to identify vertical label face that is used to display a container and or content of the container. The label attaches to any part of a container to identify but not limited to the contents, name, brand, cause, purpose, person, season or medication. The primary purpose of the invention is to provide an easy to identify label for products that otherwise may be difficult to distinguish between, such as spices in a spice cabinet or medication in a medicine cabinet. The label can be formed to be the physical cap or lid to the container, and may include other elements such as a slide-in label or a straw for a drink container. The vertical label face could be affixed to the base of the label such that it can hinge up and down.

### CROSS-REFERENCE TO RELATED APPLICATION

This application is a continuation-in-part of and claims priority in U.S. patent application Ser. No. 15/677,879 filed Aug. 15, 2017, which claims priority in U.S. Provisional Patent Application No. 62/375,099, filed Aug. 15, 2016, which is incorporated herein by reference.

### BACKGROUND OF THE INVENTION

### 1. Field of the Invention

The present invention relates generally to a label system and method for use thereof, and more specifically to a three-dimensional label for use with containers and other objects.

### 2. Description of the Related Art

Existing labels typically are located on the body of containers or on the tops of the containers. This can make it difficult to quickly identify a container when it is stored amongst other similarly shaped containers, such as in a spice shelf or medicine cabinet. What is needed is a label that can easily be viewable amongst several similarly shaped containers or items from all directions and which can be customized.

Heretofore there has not been available a system or method for a three-dimensional container label with the advantages and features of the present invention.

### BRIEF SUMMARY OF THE INVENTION

The present invention generally provides a three-dimensional label with an easy to identify vertical label face that is used to display a container and/or contents of the container. The label attaches to any part of a container to identify but is not limited to the contents, name, brand, cause, purpose, person, season or medication. The primary purpose of the invention is to provide an easy to identify label for products that otherwise may be difficult to distinguish between, such as spices in a spice cabinet or medication in a medicine cabinet.

The label could contain a picture for visually impaired or illiterate persons, braille for the blind, or words or colors as desired by the user. The vertical face could be labeled, and the horizontal faces could also be labeled or could contain other information, such as purchase or expiration date (for foods and spices) or dosage instructions (for medications). Other possible labels include business taglines or company identifying marks, such as trademarks and logos.

The label could be used on other items other than containers, such as to identify inventory or products on shelves. The label could even be used as three-dimensional business cards or for other identification purposes.

### BRIEF DESCRIPTION OF THE DRAWINGS

The drawings constitute a part of this specification and include exemplary embodiments of the present invention illustrating various objects and features thereof.

FIG. 1 is a three-dimensional isometric view of a preferred embodiment of the present invention shown in a typical environment.

FIG. 2 is a three-dimensional isometric view of the embodiment thereof shown in isolation.

FIG. 3 is a front elevational view thereof.

FIG. 4 is a right side elevational view thereof, the left side view being a mirror image thereof.

FIG. 5 is a top plan view thereof.

FIG. 6 is a three-dimensional isometric view of the embodiment thereof shown in an alternative orientation in an alternative environment.

FIG. 7 is a top isometric view of an alternative embodiment of the present invention shown in an unfolded orientation.

FIG. 8 is a top isometric view thereof shown in a folded orientation.

FIG. 9 is a top isometric view thereof shown in a folded orientation and in proximity with a base block.

FIG. 10 is a top plan view of another alternative embodiment of the present invention shown in an unfolded orientation.

FIG. 11 is a top plan view thereof shown in a folded orientation.

FIG. 12 is a side elevational view thereof showing the process of transforming the embodiment thereof from a first, unfolded orientation into a second, folded orientation.

FIG. 13 is a front elevational view of yet another alternative embodiment thereof.

FIG. 14A is a three-dimensional isometric view of yet another alternative embodiment of the present invention including a sound alert feature.

FIG. 14B is a three-dimensional isometric view of the embodiment thereof including a visual alert feature.

FIG. 15 is a three-dimensional isometric view of even yet another alternative embodiment of the present invention.

FIG. 16 is a frontal three-dimensional isometric view of even yet another alternative embodiment of the present invention.

FIG. 17 is a three-dimensional isometric view of another alternative embodiment of the present invention shown in a typical environment.

FIG. 18 is a front elevational view thereof shown in an flat orientation.

FIG. 19 is a front elevational view of a slightly altered design thereof.

FIG. 20 is a three-dimensional isometric view of another alternative embodiment of the present invention with foldable flaps.

FIG. 21 is a three-dimensional isometric view of yet another alternative embodiment of the present invention with a spiked portion.

FIG. 22 is a three-dimensional isometric view of another alternative embodiment three-dimensional label and container lid.

FIG. 23 is a three-dimensional isometric view of another alternative embodiment three-dimensional label.

FIG. 24 is three-dimensional isometric view of another alternative embodiment three-dimensional label and container lid.

FIG. 25 is a three-dimensional isometric view of another alternative embodiment three-dimensional label and container lid shown in a closed orientation.

FIG. 26 is a three-dimensional isometric view thereof shown in an open orientation.

FIG. 27 is a detailed view taken about the circle of FIG. 26.

FIG. 28 is three-dimensional isometric view of another alternative embodiment three-dimensional label and container lid.

FIG. 29 is front elevational view of another alternative embodiment three-dimensional label.

FIG. 30 is a side elevational view thereof.

FIG. 31 is a top plan view thereof.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as oriented in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning. Additional examples include a mobile smart device including a display device for viewing a typical web browser or user interface will be commonly referred to throughout the following description. The type of device, computer, display, or user interface may vary when practicing an embodiment of the present invention. Said terminology will include the words specifically mentioned, derivatives thereof and words of similar meaning.

### II. Preferred Embodiment Labeling System 2

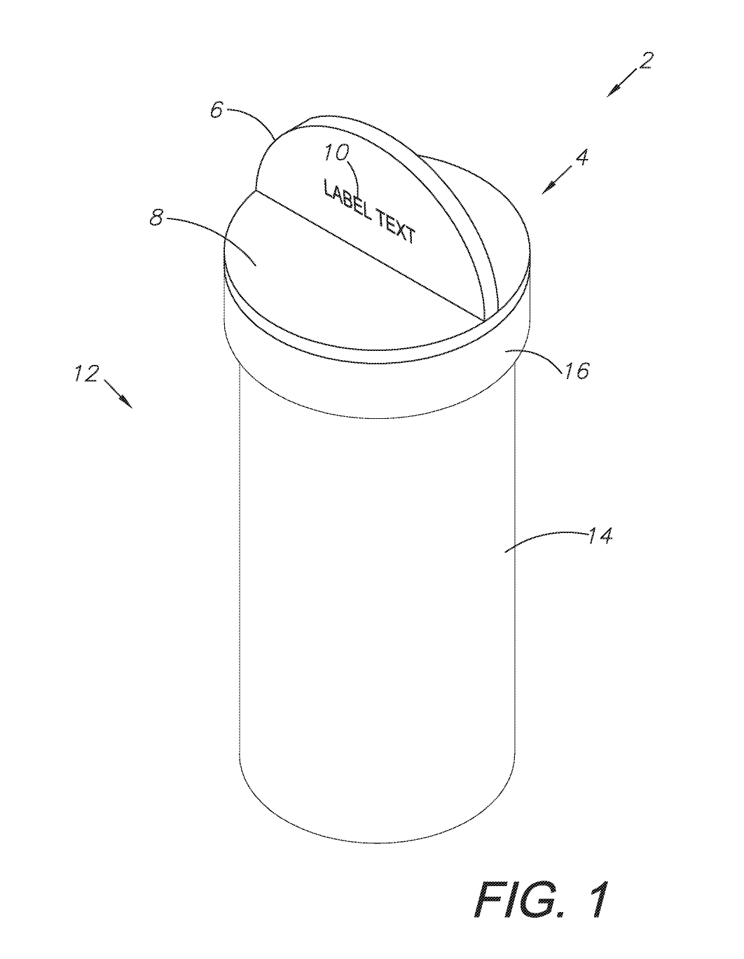

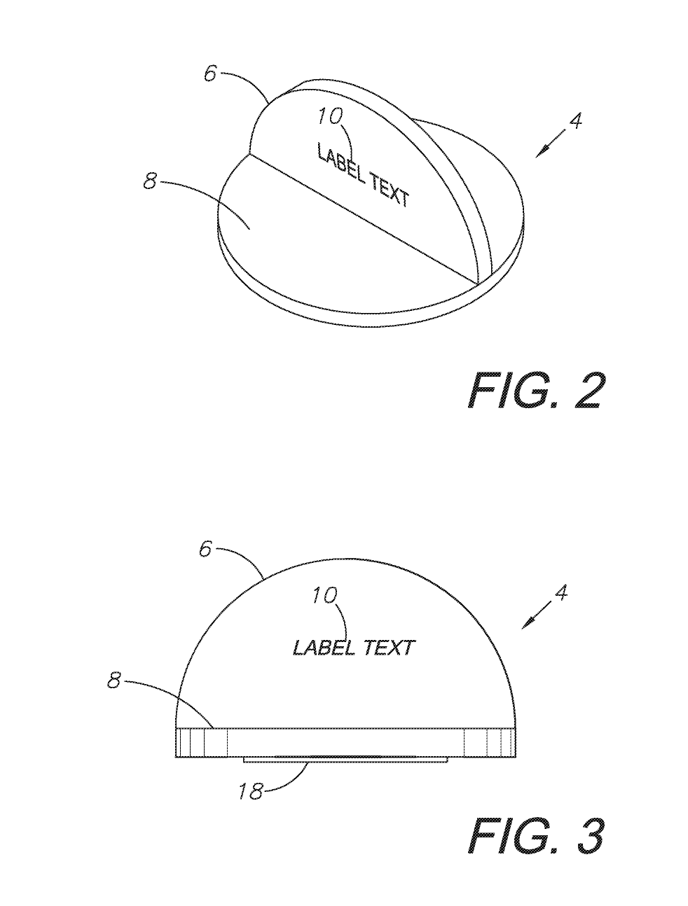

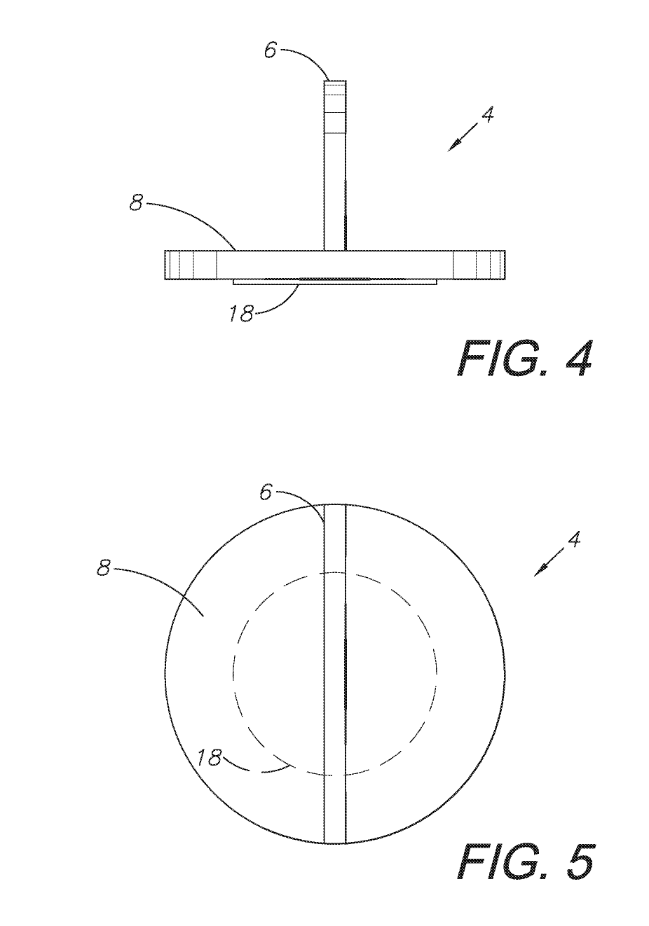

As shown in the FIGS. 1-5, the primary purpose of the present invention is to provide a three-dimensional label 4 for easy identification of goods, such as containers 12 (e.g. spices and medicines). The primary components of the label 4 are a base unit 8 which is affixed to the container lid 16 atop a container body 14, or any other item, and a vertical top portion 6 which extends perpendicularly from the base including a face which contains an identifier 10, such as words, symbols, pictures, colors, or even braille.

FIGS. 1-5 show a solid embodiment of the present invention which could come out of the package ready to use. An adhesive disc element 18 is applied to the bottom of the base 8, such as a reusable adhesive sticky pad. The structure of the embodiment allows the user to use the vertical portion 6 of the label to open bottle containers using the label itself, providing an easier way to open the lids for people who have difficulties with their hands or fingers. The label 4 can also be used to more easily pick up the container.

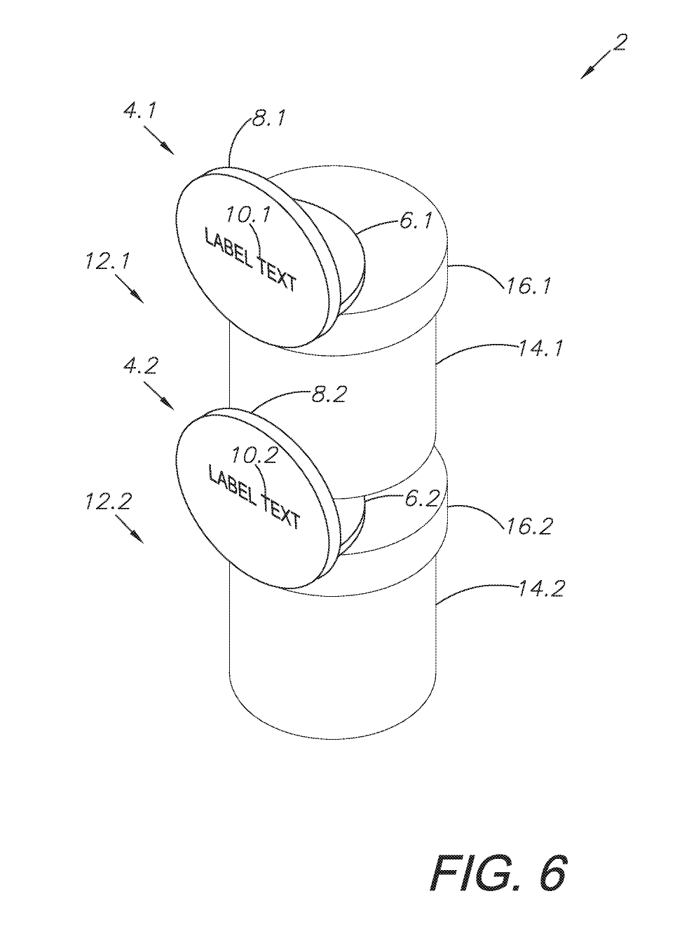

FIG. 6 shows the label 4 being used in an alternative orientation, where a first label 4.1 is placed atop a first container 12.1 having a body 14.1 and lid 16.1 by the top portion 6.1 of the label 4.1. The text 10.1 is located on the bottom face of the base 8.1 in this orientation. This entire combination is stacked atop at least a second container 12.2 having a body 14.2 and lid 16.2 by the top portion 6.2 of the second label 4.2. The text 10.2 is located on the bottom face of the base 8.2 as above. This could be stacked multiple ways and in any multiple combinations.

### III. Alternative Embodiment Label System 52

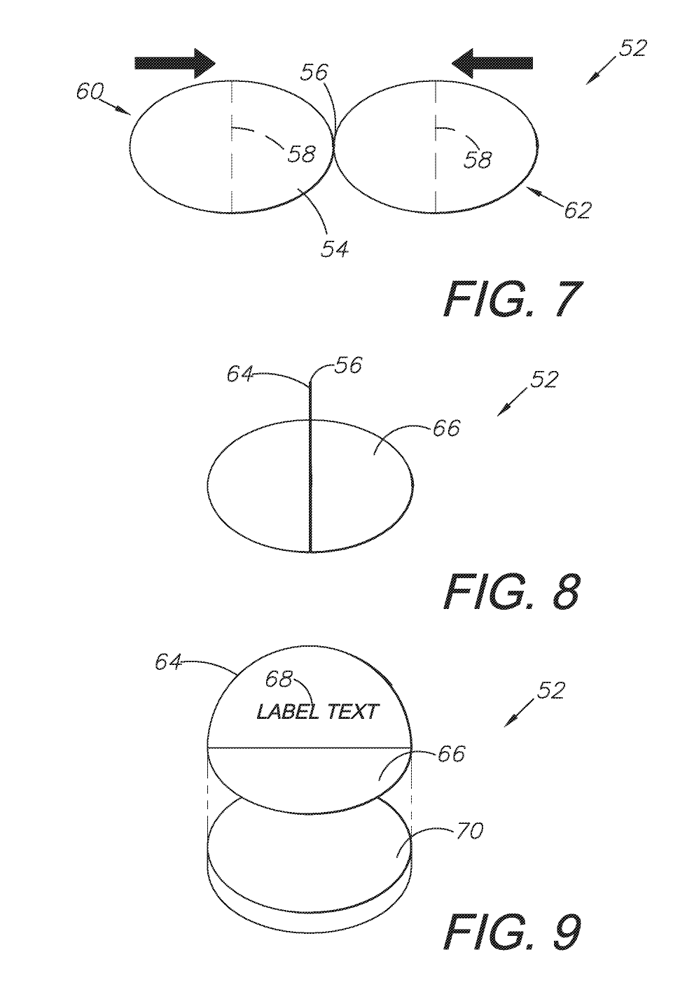

FIGS. 7-9 show a foldable embodiment of the present invention, which may be made out of heavy paper, vinyl, plastic, or any other suitable material cut into a flat base 54. The device would have score lines 58 for folding the central portion up to form the vertical element 64 of the label, whereby the base 66 is formed by the second halves of the first 60 and second 62 circles. The two circles 60, 62 are joined at a central portion 56. This embodiment could be used without a substrate or with a substrate, as shown in FIGS. 5-7. The substrate could provide additional structure and stability to the device. This embodiment makes a product which is smaller in shape, and therefore easier to store and ship. The label text 68 would appear on the vertical portion 64. An optional cylindrical substrate base 70, made of a sturdy material such as wood, plastic, cardboard, or other suitable material could be affixed to the base 66 for a more sturdy label.

### IV. Alternative Embodiment Label System 102

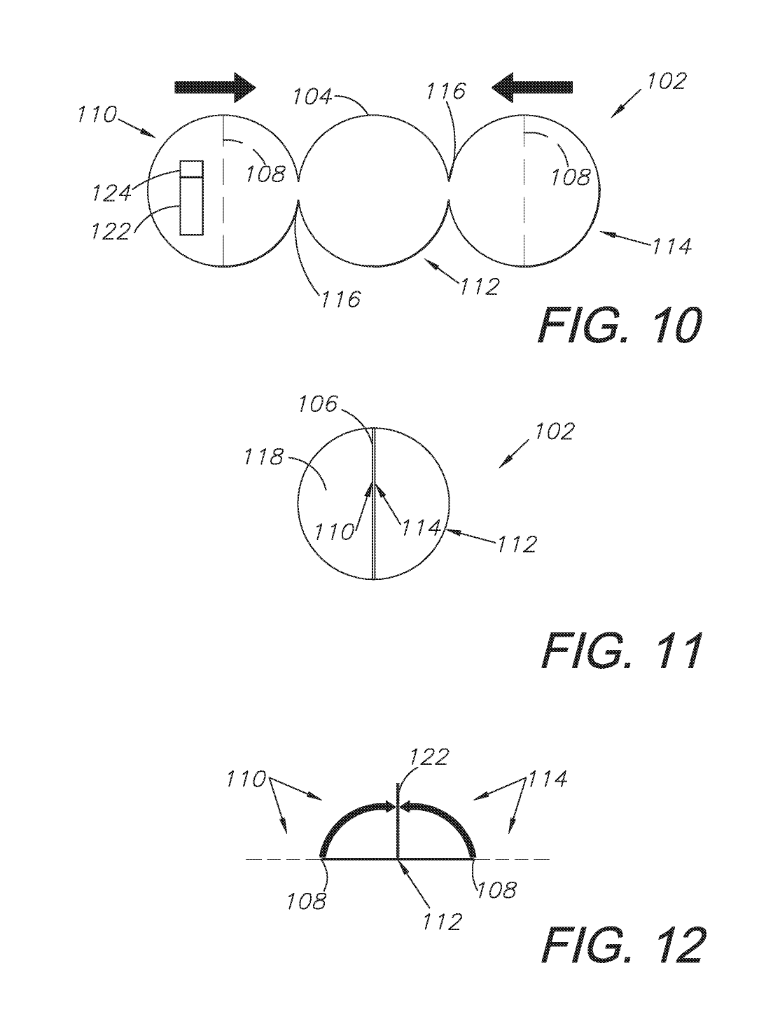

FIGS. 10-12 show a slightly alternative embodiment of a foldable embodiment 104 including a basic three-circle device with score lines 108 allowing the device to be folded up. This design makes the need for the substrate 70 shown in the previous embodiment irrelevant. A ready-to-use adhesive strip 122 could be applied to one or more faces of the device, as shown in FIG. 12, which can allow the vertical portion 106 to be easily formed out of the two edges 110, 114 as shown in FIG. 12. The base portion 118 is then formed out of the center circle 112 and the other halves of the outer circles 110, 114. The three circles 110, 112, 114, are separated by center portions 116 which allow folding about those portions. The adhesive strip 122 includes a pull-away cover 124 which exposes the adhesive, allowing the two side circles 110, 114 to be folded together to form the base 118 and vertical portions 106 of the label.

### V. Alternative Embodiment Label System 152

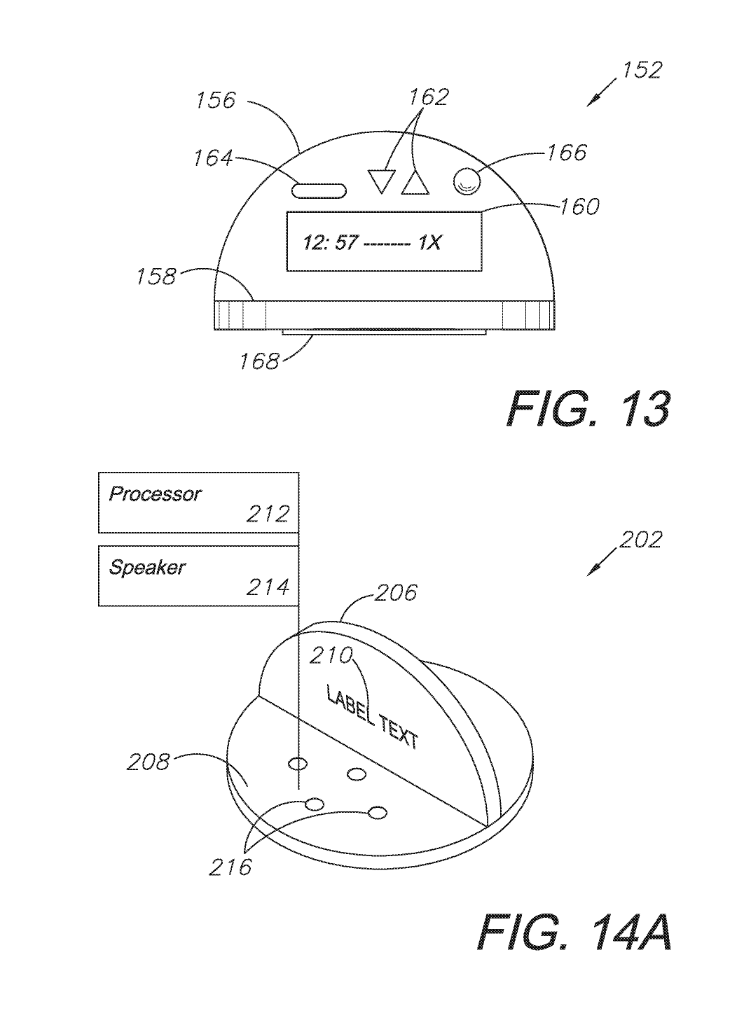

FIG. 13 shows a digital version of a label system 152 similar to those disclosed above. The label includes a base portion 158 and a vertical top portion 156. The top portion includes an LCD screen 160 which could include the label text, a timer, or other data. A set button 164, adjustment buttons 162, and LED alert device 166 round out the digital portion of the device. A processor, battery, and other devices may be needed to add functionality to the device. The adjustment buttons 162 adjust timer settings, and the set button 164 will set the alarm. When it is time to open the container the label 152 is placed upon (e.g., medicine container), the alert sounds and the light 166 flashes. A speaker may also be included. An adhesive disc 168 is placed on the bottom face of the base portion 158 and allows the label to be adhered to a container.

### VI. Alternative Embodiment Label System 202

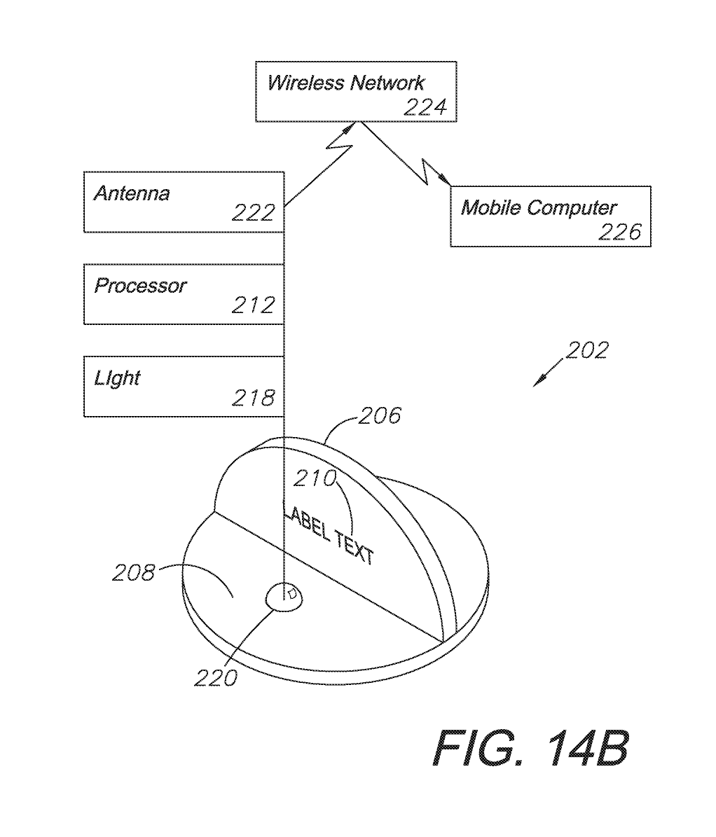

FIGS. 14A and 14B show yet another alternative embodiment label system 202. Here, the base portion 208 and top portion 206 are very similar to the previous embodiments, including the label text 210 on the top portion. However, a processor 212 is included which is connected to a speaker 214 which may produce audio through a plurality of audio holes 216.

Alternatively, as shown in FIG. 14B, a light element 220 including a light source 218 could be used for hearing-impaired users. The speaker 214 or light 218 can be used to alert a user when they should open the container and take their medicine or for other alert purposes. An antenna 222 may also be included to connect the label 202 through a wireless network 224, such as the internet, to a wireless mobile computer 226, such as a smartphone or laptop computer. This allows the alert to be sent to the user at a remote location, not within audio or visual contact of the label 202.

### VII. Alternative Embodiment Label System 252

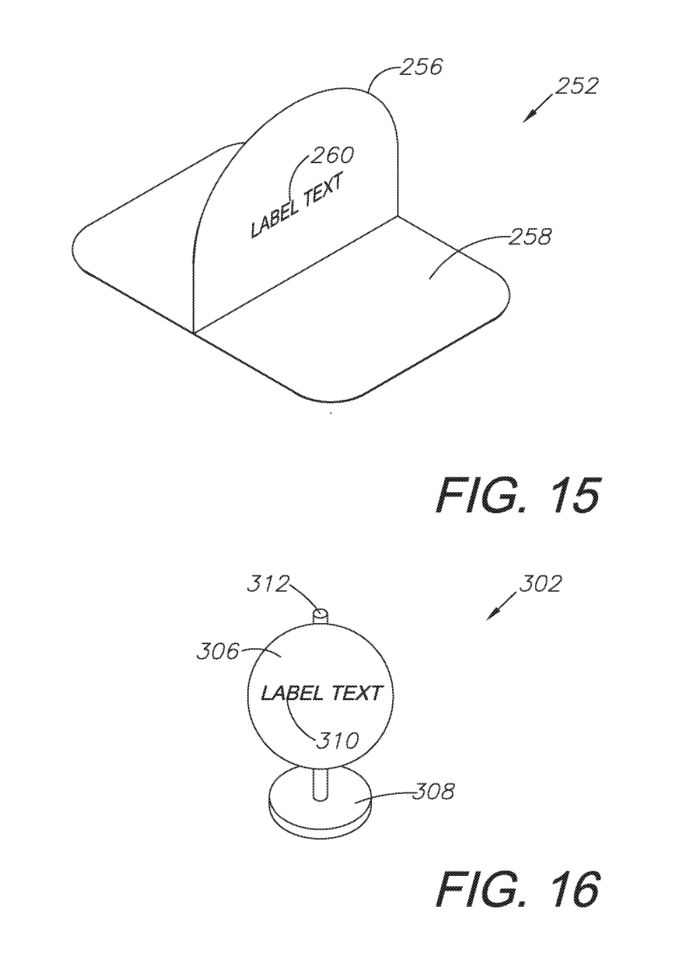

FIG. 15 shows a slightly alternative embodiment label system 252 made again of a base portion 258, vertical top portion 256, and label text 260. Such a label could be folded up from a business card or other flat card-shaped element.

### VIII. Alternative Embodiment Label System 302

FIG. 16 shows yet another slightly alternative embodiment label system 302 including a base portion 308, vertically oriented top portion 306 including label text 310, and the vertical portion being supported by a vertical rod 312.

### IX. Alternative Embodiment Label System 352

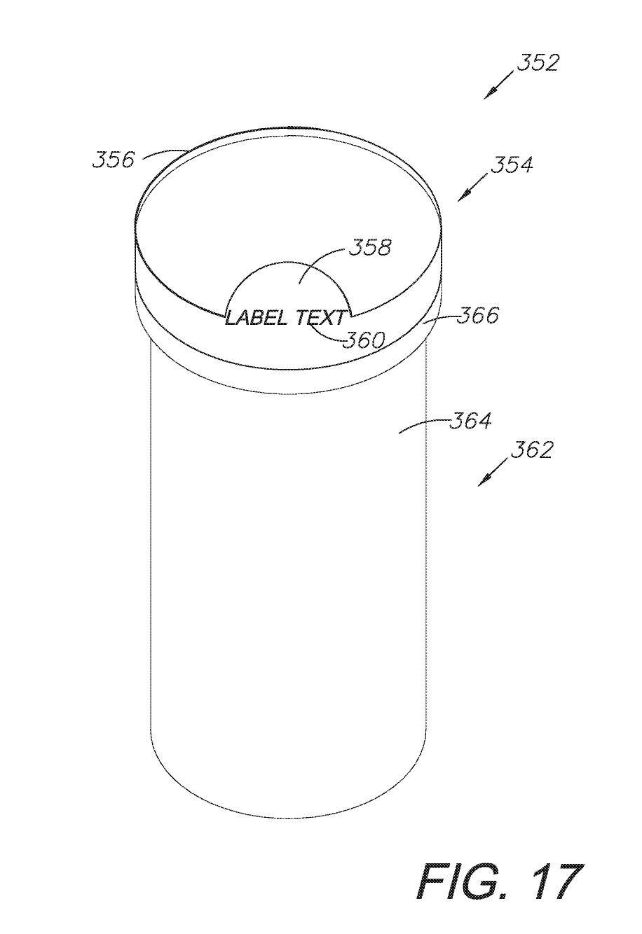

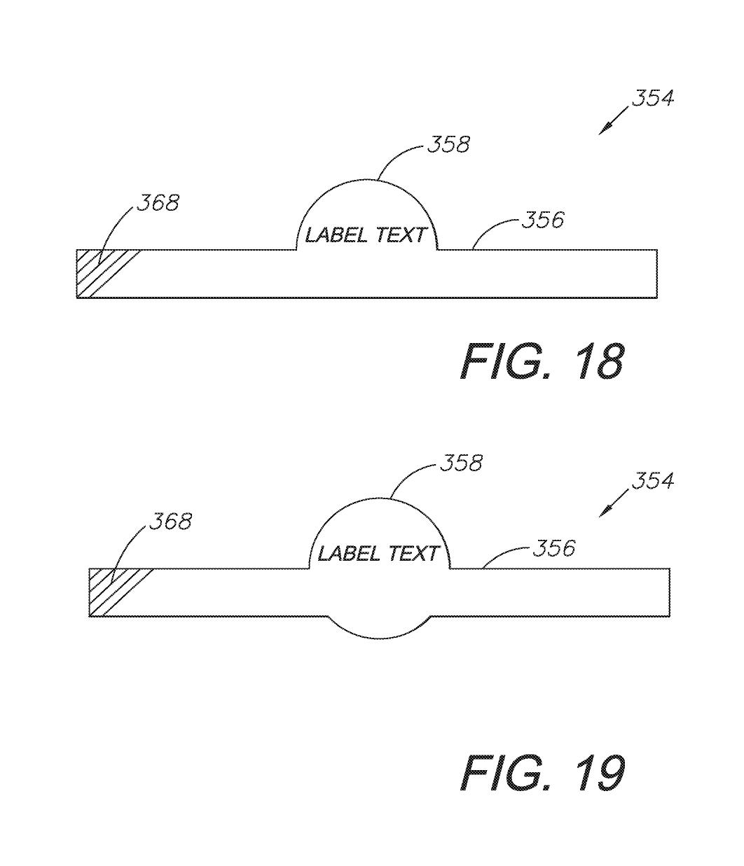

FIGS. 17-19 show another alternative embodiment label system 352 of a label 354 shown in a typical environment about a container lid 366 atop a container body 364 of a container 362. The label 354 is formed from a banded portion 356 and a label-face portion 358 including the label text 360. FIG. 19 shows a slightly alternative design in the label-face portion 358. An adhesive portion 368 can be peeled away to allow the two halves of the banded portion 356 to connect firmly about the container 362.

### X. Alternative Embodiment Label 404

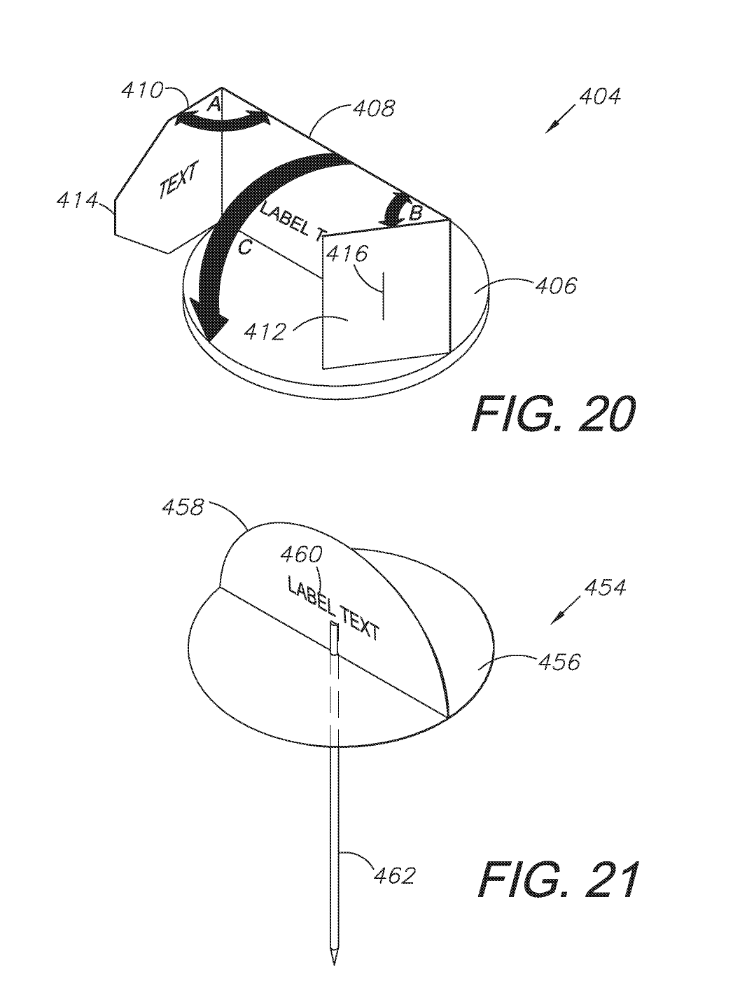

FIG. 20 shows another alternative embodiment label 404 which has a base 406 similar to other embodiments disclosed above. A top flap 408 which can fold along arrow C as shown in FIG. 20 contains label text. A first flap 410 and second flap 412 can fold out from the top flap 408 and can contain other text, images, or information. The first flap 410 may include a tab 414 which slots into a slit 416 of the second flap, allowing the first flap 410 and second flap 412 to close against the top flap 408.

### XI. Alternative Embodiment Label 454

FIG. 21 shows another alternative embodiment label 454 which includes a top portion which is very similar to some of the embodiments disclosed above, including a base portion 456 and a top portion 458 perpendicular to the base portion. Label text 460 is placed on the vertically oriented top portion. A spike 462, such as a toothpick or metal wire, is inserted or otherwise affixed to the base 456 and/or top portion 458 and allows the label to be inserted into food, containers, a paper label for a bottle, or other uses such as in potted plants or gardens.

Alternative uses of the invention include use as a three-dimensional business card or name tag (see FIG. 15). As a name tag, the device could be affixed to the base of a wine glass or other object to identify an object to its owner. Other features may include LED lights or other lighting elements attached to the base portion of the device to illuminate the vertical face, or placed in proximity with the device itself.

### XII. Alternative Embodiment Lid with Label 502

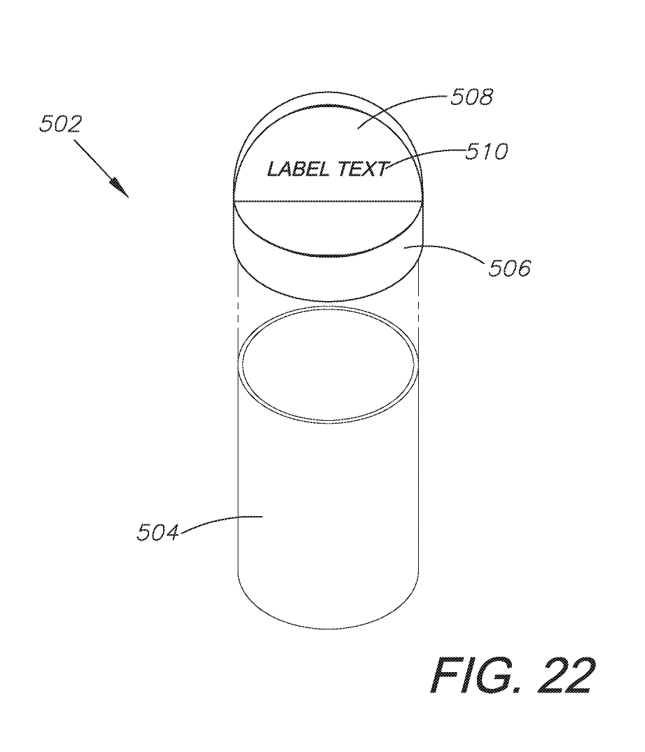

As shown in FIG. 22, an alternative embodiment lid with label 502 for use with a container 504. As with the previous embodiments, the vertically oriented label portion 508 includes label text 510 to describe the contents of the container 504. The label portion 508 is affixed to the lid 506 which seals the container 504. This could be as simple as capping the container, screwing onto the container using threads, or any common type of lid and container connection. In this embodiment, the lid 506 and label 508 are one solid piece, such as molded plastic or metal, and the label 508 makes it easier to identify the contents of the container 504 when placed in a crowded self, and also makes it easier to pick up the container and to remove the lid by providing a gripping surface. The container 504 could be any typical container, such as a plastic container for medicines or spices, a glass candle container, a drink container, or any suitable container.

### XIII. Alternative Embodiment Label 552

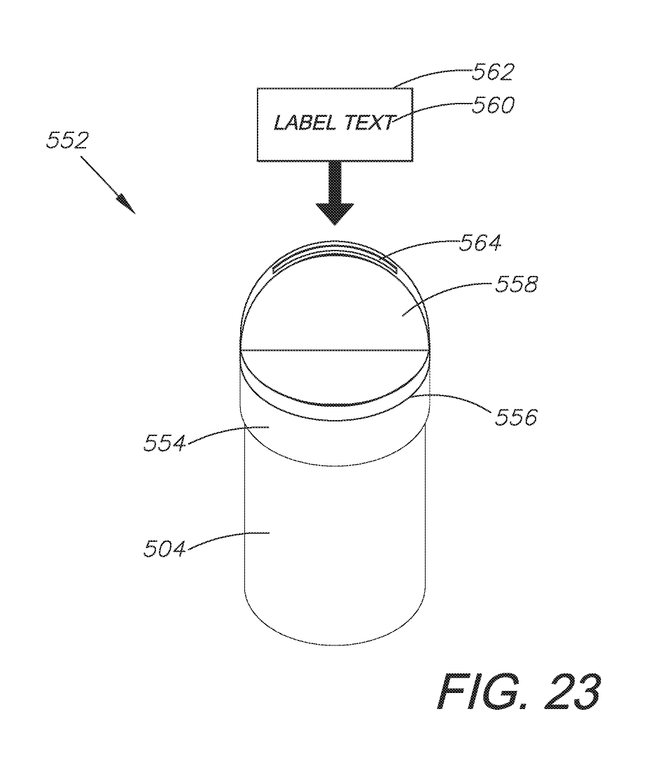

As shown in FIG. 23, an alternative embodiment label 552 provides another embodiment of the labels discussed above. Here, the label portion 558 is a transparent or semi-transparent vertical structure which is affixed to a base 556 which is attached to the lid 554 of a container 504 using adhesive strips or some other type of semi-permanent connection. The label 558 includes a slot 564 which receives a removable label strip 562 which includes the label text 560. This allows for the label to be changed as desired to correspond with the contents of the container 504. The user can simply remove the label strip 562 and replace it with an updated label strip as desired. The label text 560 could be hand written, printed and purchased, or could contain a picture or diagram of what is contained within the container. The transparent vertical label 558 allows the user to view the label text 560 through the wall of the label, while providing the same advantages as discussed with previous embodiments.

### XIV. Alternative Embodiment Label and Container 602

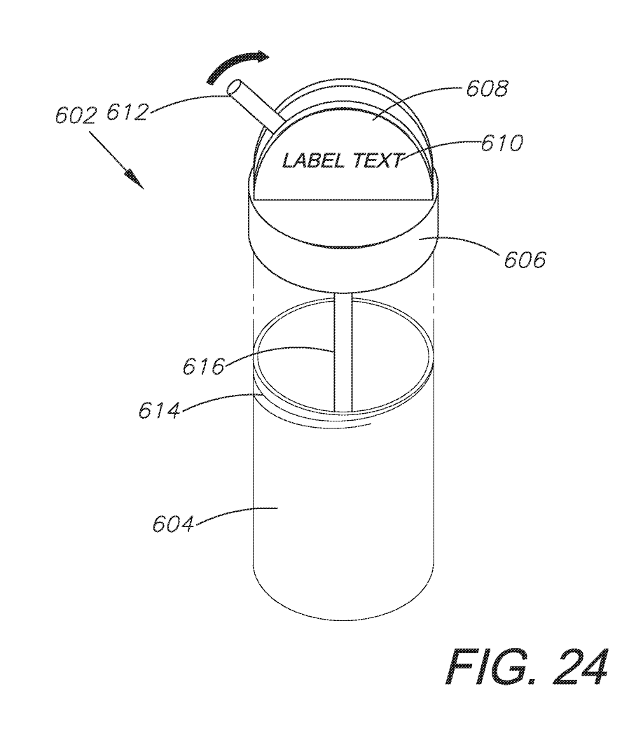

As shown in FIG. 24, a label and container 602 can be assembled using a similar three-dimensional label having a vertically oriented label portion 608 with label text 610 and a base 606 forming a cap for the container 604. As shown, the container 604 contains threads 614 for threadably receiving the cap 606, but any connection type could be used. An upper straw element 612 is contained within the vertical label 608, and may be able to be tilted within the vertical label portion to be stored when not in use. The upper straw 612 connects to a lower straw 616 which is connected to the base of the cap 606 and extends into the container for drawing liquid up and out the upper straw element 612.

### XV. Alternative Embodiment Label and Container System 652

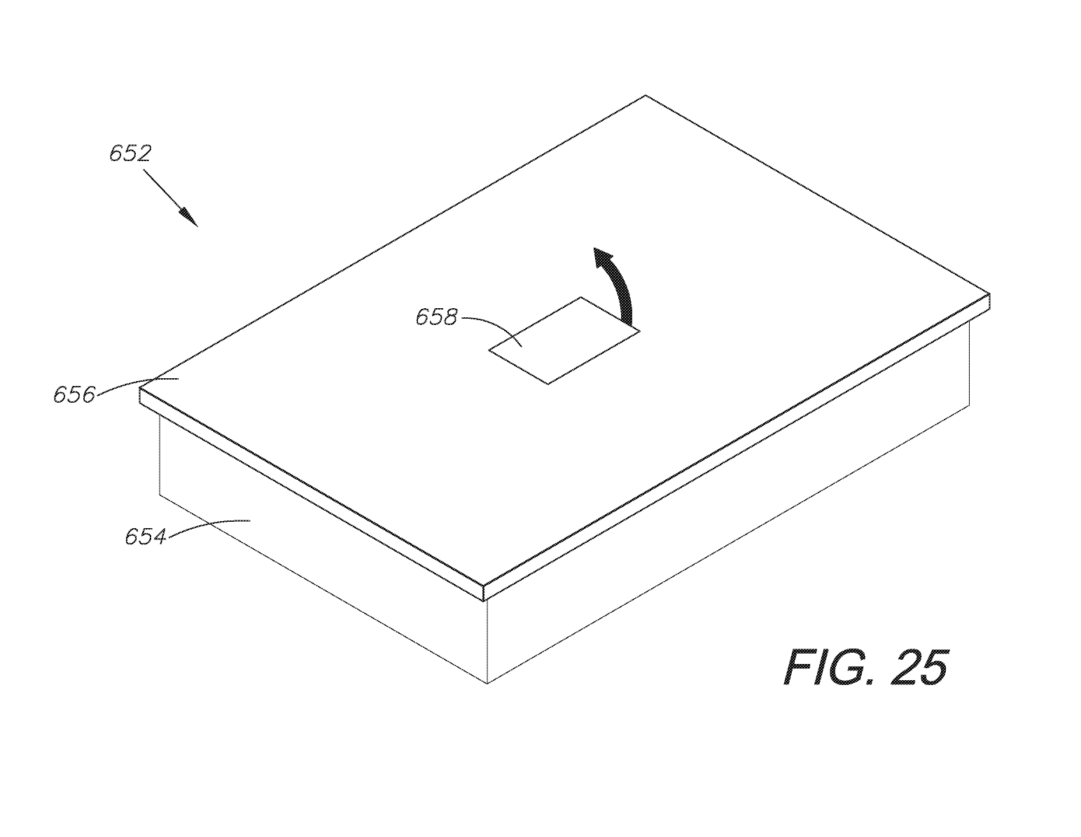

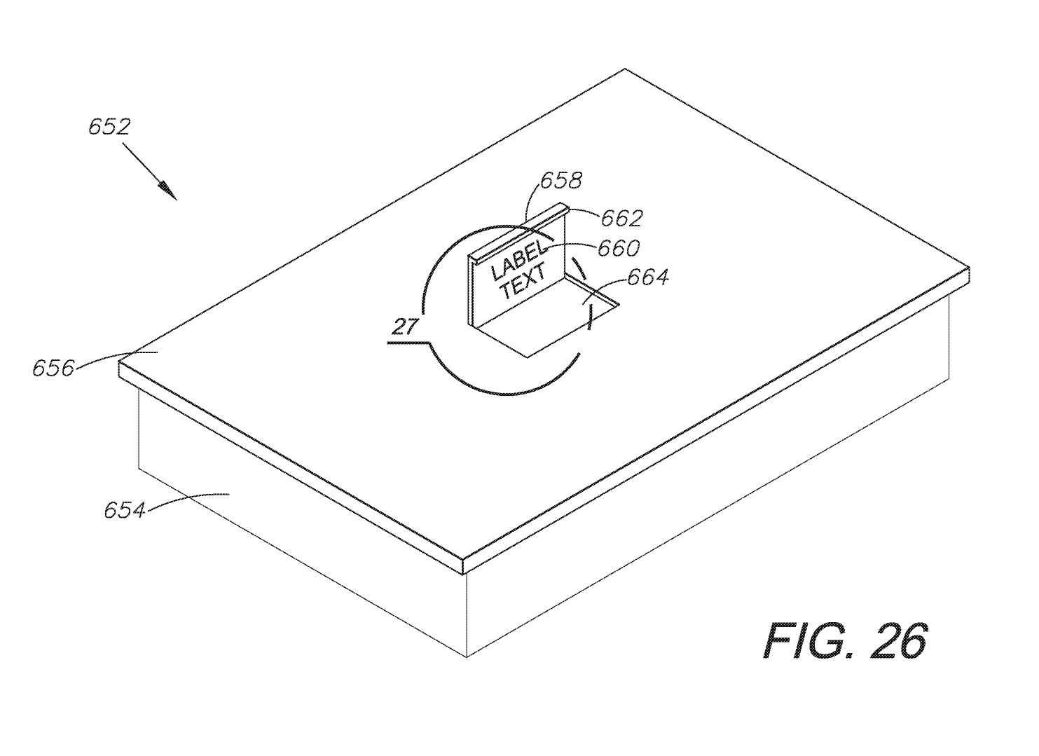

As shown in FIGS. 25-27, another label system 652 can be employed with cake pans, Tupperware® containers, or other such storage containers 654. The lid 656 sits atop the container 654 and includes a label portion 658 which can be flipped up and locked in place to display the label text 660 as shown in FIG. 26. A relief 664 within the lid 656 allows the label portion 658 to sit flush with the lid when closed and flipped down. A notch 662 is received within the relief 664 by a receiver 666 which locks the label portion 658 in place until the user wishes to flip it back up. A hinge 668, such as a living hinge or a pin, allows the label 658 to flip up and down.

### XVI. Alternative Embodiment Label and Lid System 702

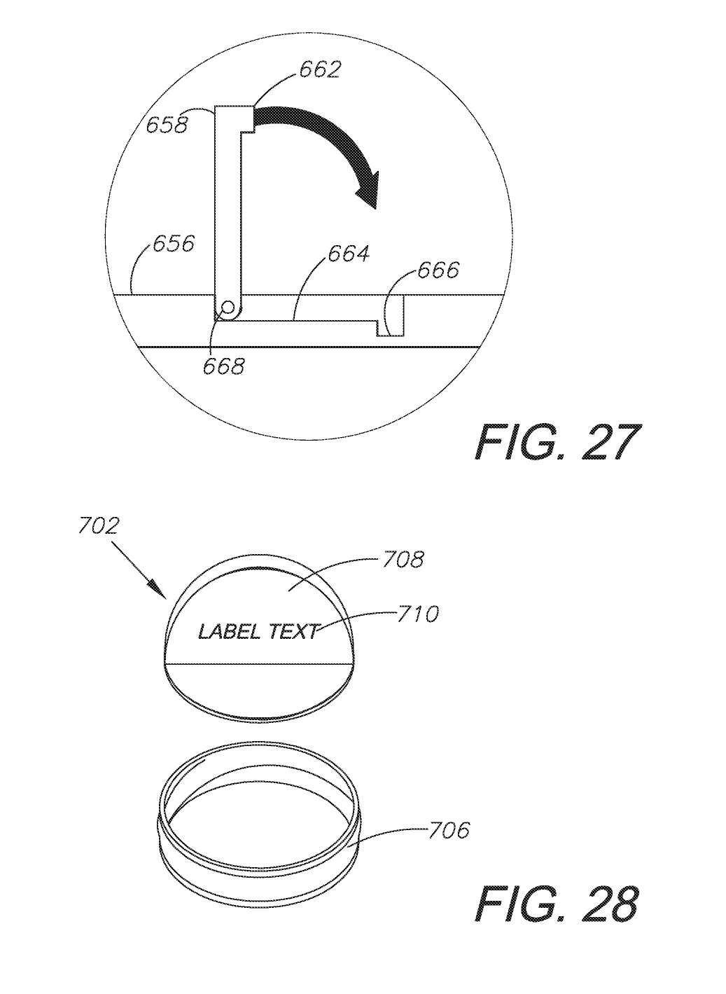

As shown in FIG. 28, a lid and label system 702 for use with mason jars employs a metal label 708 with label text 710 and a metal base which is locked atop the jar or container (not shown) with a metal ring 706 as is typical for canning or jarring using mason jars. The label 708 is formed from a single piece of metal or plastic. The upper portion could flip up and down in an embodiment, or may be permanently upright.

### XVII. Alternative Embodiment Label 752

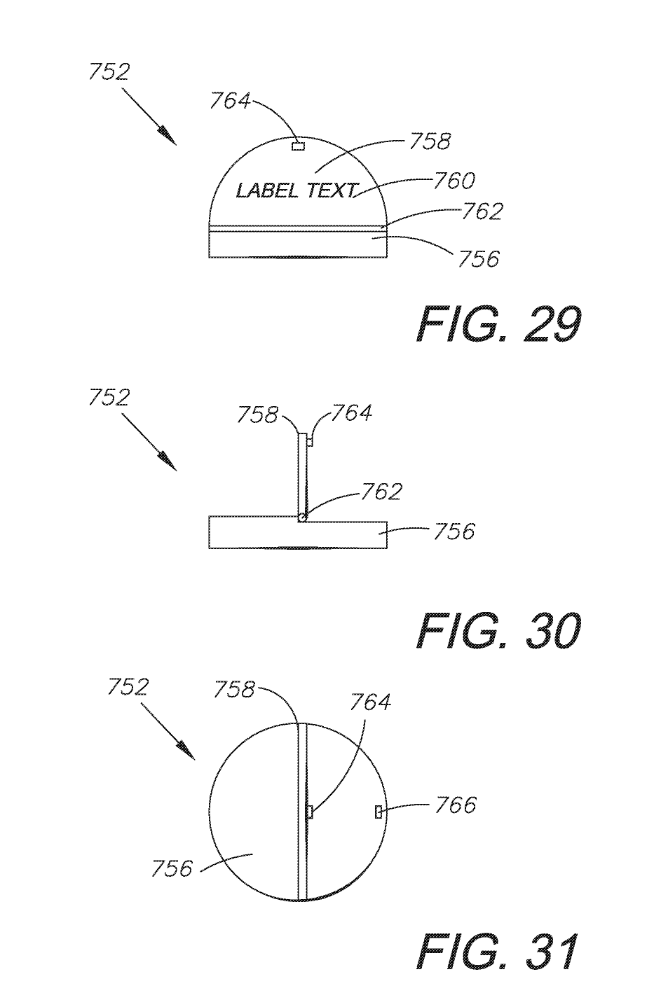

As shown in FIGS. 29-31, the three-dimensional label 752 could be formed from molded plastic or metal and includes a base 756 which could function as a cap for a container, as in embodiments above, or could be attached to an existing cap for the container. The label 752 includes a vertical label portion 758 which is attached to the base either through a living hinge 762, pin, or other permanent means of allowing the vertical label portion 758 to tilt upwards to present the label text 760. The vertical label portion 758 could also be tilted down and locked to the base by connecting a tab 764 into a receiver 766 on the base 756.

This label system 752 could be employed within existing caps and lids for containers, including juice or drink containers, candles, spices, medicines, or any and all containers with lids. The label system 752 could also be attached to other items such as bulk goods bins for a quick and easy identification system.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A three-dimensional labeling system comprising:
a three-dimensional label having a base portion and a top portion;
said top portion being perpendicular to said base portion;
said base portion and said top portion configured for receiving label information; and
said top portion affixed to said base portion via a hinged connection, such that said top portion can be positioned from a first, stored position parallel to said base portion to a second, upright position perpendicular to said base portion.

2. The system of claim 1, further comprising:
said base portion being generally circular in shape;
said top portion comprising a half-circle; and
said base portion configured for being placed atop a container.

3. The system of claim 1, wherein said base portion comprises a lid for sealing a container.

4. The system of claim 3, wherein said base portion comprises threads for threadably connecting to and sealing said container.

5. The system of claim 3, wherein said base portion comprises a lip configured for gripping to edges of said container and thereby sealing said container.

6. The system of claim 5, further comprising:
wherein said container is a rectangular storage container; and
said lid is a rectangular storage container lid.

7. The system of claim 3, further comprising:
said base portion being generally circular in shape;
said top portion comprising a half-circle; and
said top portion configured for being gripped for removing said lid from said container.

8. The system of claim 3, further comprising:
a first tubular straw element connected to a top side of said base portion through a slot within said top portion;
a second tubular straw element connected to a bottom side of said base portion, said second tubular straw and said first tubular straw thereby connected through said base portion;
said second tubular straw element configured for being displaced within said container; and
whereby liquid stored within said container can be drawn through said second tubular straw element, said base portion, and said first tubular straw element.

9. The system of claim 7, wherein said first tubular straw element is hingedly engaged within said slot such that it can be tilted from a first, stored position within said top portion to a second, deployed position extending out of said top portion.

10. The system of claim 1, further comprising:
said top portion comprising a connecting nodule;
said base portion comprising a receiver slot; and
wherein said receiver slot is configured for receiving and locking said connection nodule within itself.

11. The system of claim 1, further comprising:
said top portion including a front face comprised of a semi-transparent material;
said top portion comprising a slotted receiver along a top edge of said top portion; and
said slotted receiver configured to receive a label, said label viewable through said front face.

12. A three-dimensional labeling system comprising:
a three-dimensional label having a base portion and a top portion;
said top portion being perpendicular to said base portion;
said base portion and said top portion configured for receiving label information;
said top portion affixed to said base portion via a hinged connection, such that said top portion can be positioned from a first, stored position parallel to said base portion to a second, upright position perpendicular to said base portion;
said top portion comprising a half-circle;
said base portion comprising a container lid; and
said top portion configured for being gripped for removing said lid from said container.

13. The system of claim 12, wherein said base portion comprises threads for threadably connecting to and sealing said container.

14. The system of claim 12, wherein said base portion comprises a lip configured for gripping to edges of said container and thereby sealing said container.

15. The system of claim 14, further comprising:
wherein said container is a rectangular storage container; and
said lid is a rectangular storage container lid.

16. The system of claim 12, further comprising:
said base portion being generally circular in shape;
said top portion comprising a half-circle; and
said top portion configured for being gripped for removing said lid from said container.

17. The system of claim 12, further comprising:
a first tubular straw element connected to a top side of said base portion through a slot within said top portion;
a second tubular straw element connected to a bottom side of said base portion, said second tubular straw and said first tubular straw thereby connected through said base portion;
said second tubular straw element configured for being displaced within said container; and
whereby liquid stored within said container can be drawn through said second tubular straw element, said base portion, and said first tubular straw element.

18. The system of claim 17, wherein said first tubular straw element is hingedly engaged within said slot such that it can be tilted from a first, stored position within said top portion to a second, deployed position extending out of said top portion.
